(19) United States
(12) Patent Application Publication
(10) Pub. No.: US 2010/0249309 A1
(43) Pub. Date: Sep. 30, 2010

(54) NANOCOMPOSITES AND THEIR SURFACES

(76) Inventors: Menachem Lewin, Jerusalem (IL); Yong Tang, Anhui (CN)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/593,813

(22) PCT Filed: Apr. 2, 2008
(86) PCT No.: PCT/US08/59140

§ 371 Date: Jun. 3, 2010

Related U.S. Application Data
(60) Provisional application No. 60/910,234, filed on Apr. 5, 2007.

(51) Int. Cl. C08K 3/34

(52) U.S. Cl. 524/445

(57) ABSTRACT

A method for preparing nanocomposites and nanocomposite polymeric products by dispersing nanoparticles in a polymer either by melt processing or by solution processing and bringing about migration of the nanoparticles from the bulk interior to the surface of the nanocomposites so as to produce a new asymetric type of nanocomposite in which the concentration of the nanoparticles on the surface is many times higher than in the interior bulk of the nanocomposite. These surfaces impart highly enhanced properties to the nanocomposites as compared to the pristine polymer and to nanocomposites that have not undergone the migration process, including stability against aging, longer shelf life, higher hydrophobicity, higher wear resistance, higher hardness and lower friction. The new surfaces of the nanocomposite polymeric products are produced by inducing migration of the nanoparticles to the surface thereby producing a concentration gradient below the surface.

### STATEMENT OF RELATED APPLICATIONS

This application is the U.S. National Phase Under Chapter II of the Patent Cooperation Treaty (PCT) of PCT International Application No. PCT/US2008/059140 having an International Filing Date of 2 Apr. 2008, which claims priority on U.S. Provisional application No. 60/910,234 having a filing date of 5 Apr. 2007.

### STATEMENT OF GOVERNMENT INTEREST

This invention was sponsored by the United States National Science Foundation under contract no. NSF (DMR) 0352558 and the US National Institute for Standards and Technology under contract no. NIST 4H1129.

### BACKGROUND OF THE INVENTION

1. Technical Field

The present invention generally is in the fields of (a) preparing new surfaces of nanocomposite products and (b) preparing nanocomposites based on nonpolar polymers. The present invention more specifically is in the fields of (a) preparing new surfaces of nanocomposite products by inducing migration of nanoparticles to the surface thereby increasing the concentration of the nanoparticles on the surface of the nanocomposite and producing a gradient of concentrations below the surface of the nanocomposite and (b) preparing nanocomposites based on nonpolar polymers by dispersing nanoparticles in a polymer in the presence of a mildly oxidizing agent.

2. Prior Art

Polypropylene (PP) is the most widely used polymer in the preparation of nanocomposites. It can be preferable to other polymers due to its ready availability, relatively low cost, and many possible applications. However, the apolarity and low surface tension of polypropylene present difficulties in the dispersion of hydrophilic clays in this hydrophobic polymer. Several systems have been designed and developed to overcome these difficulties. These systems include the addition of polar functional groups to the polypropylene macromolecules. In one system, styrene monomers were copolymerized with polypropylene. In other systems, OH, NH₂, and carboxyl groups were incorporated, and in a recent development, ammonium ion-terminated polypropylene was prepared. All approaches described until now, however, did not find any practical application due to difficulties in preparation and relatively high cost. See Wang Z. M., et al., Macromolecules 2003, 36:8919; Manias E., et al., Chem. Mater. 2001, 13:3516.

At present, the only modification applied to polypropylene for use in the preparation of nanocomposites is maleation, i.e., grafting of maleic anhydride (MA) groups onto the polymeric chain. The maleation treatment is connected with a number of complications including such side reactions as beta-scission, chain transfer, and coupling and above all, severe decrease of the molecular weight. Although interesting modifications of the maleation process were suggested recently, such as the preparation of the borane-terminated intermediate that is prepared by hydroboration of the chain-end unsaturated polypropylene, these modifications have not yet been commercially applied. The maleation process is the only one used at present and is being widely studied for a range of applications, such as metal plastic laminates for structural use, polymer blends, and lately nanocomposites such as polyhedral oligomeric silsesquioxanes (POSS). See Lu B., et al., Macromolecules 1998, 31:5943; Lu B., et al., Macromolecules 1998, 32:2525; Heinen W., et al., Macromolecules 1996, 29:1151.

### BRIEF SUMMARY OF THE INVENTION

The present invention comprises novel methods of preparing nanocomposites and polymeric nanocomposite products by dispersing nanoparticles in a polymer. The dispersion can be accomplished by, for example, dispersing the nanoparticles either in a molten polymer or in a polymer dissolved in a suitable solvent. If the nanoparticles are dispersed in a molten solvent, then, in the case of a nonpolar polymer the dispersion can be carried out in the presence of a mildly oxidizing agent. The present invention further comprises novel methods of preparing new surfaces of the polymeric nanocomposite products by inducing migration of nanoparticles to the surfaces of the matrix polymers in which they are dispersed thereby increasing the concentration of the nanoparticles on the surface and producing a gradient of concentrations below the surface in the depth of the nanocomposite. These enhanced surfaces comprise improved surface mechanical properties, such as but not limited to hardness, wear, abrasion resistance, friction, hydrophobicity, permeability to oxygen, increasing aging resistance, and decreasing photooxydation. In this way, asymmetric membranes can also be produced which may enable separation of materials.

In one exemplary embodiment, a nanocomposite is prepared using a nanoparticle such as for example POSS, montmorillonite, or organically treated montmorillonite. Exemplary polymers include but are not limited to polypropylene (PP), polyethylene (PE), ethylene-propylene copolymer (EP), polyamide (PA), polyamide 6 (PA6), polyamide 66 (PA66), poly(ethyleneterephtalate) (PET), polycarbonate (PC), poly(methyl methacrylate) (PMMA), polyimide (PI), polyphenylene oxide, polystyrene, poly(butylene terephtalate) (PBT), ethylene-vinyl copolymer (EVA), polyurea, polyurethane (PU), polyacrylates, polyacrylonitril (PAN) and styrene-acrylonitrile (SAN). Exemplary oxidizing agents include but are not limited to air and organic peroxides. In the case of clay, such as montmorillonite clay, a surfactant can be chemically linked to the aluminosilicate layers. Such a surfactant can be a quaternary ammonium compound including a long aliphatic chain composed of 10 to 18 methyl groups. Clay does not disperse in a polymer which does not contain polar groups. Existing ways to introduce polar groups into a polymer such as pristine polypropylene to compatibilize the polymer are cumbersome. The present invention addresses this problem and provides a simple way to compatibilize such polymers and involves mixing organic peroxides, air or oxygen, with the molten polymer together with the clay.

An additional problem addressed by the present invention is an improvement in surfaces of nanocomposite structures. The surfaces can be changed and improved by bringing about a migration of, for example, nanoparticles from the interior bulk of the polymer to the surface, thereby enriching the surface with the nanoparticles. Such an enrichment of the surface can be regulated by the extent of migration. For example, the surface can have a concentration of nanoparticles greater than twice the concentration of nanoparticles in the bulk interior of the nanocomposite or nanocomposite product. Such enriched surfaces have enhanced properties as compared to original nanocomposite surfaces. Such nanocomposites with enhanced surfaces can be called “second generation nanocomposites”. One such improvement expresses itself in enhanced hardness of the surface. The invention presents ways to prepare such enhanced surfaces.

### BRIEF DESCRIPTION OF THE DRAWINGS

FIG. 1 illustrates octoisobutile polyhedral oligomeric silsesquioxanes.

FIG. 2 is an AFM image of the surface resulting from Example 30.

FIG. 3 is an SEM image of the surface resulting from Example 30.

### DETAILED DESCRIPTION OF PREFERRED EMBODIMENTS

The phenomenon of the migration of clay to the surface upon annealing at elevated temperatures has been discussed recently by one of the present inventors, Menachem Lewin. See Lewin M., et al., Nanocomposites At Elevated Temperatures: Migration And Structural Changes, Polym. Adv. Technol. 2006, 17:226; Lewin M., Reflections On Migration Of Clay And Structural Changes In Nanocomposites, Polym. Adv. Technol. 2006, 17:758; Zammarano, M., et al., The Role Of Oxidation In The Migration Mechanism Of Layered Silicate In Poly(propylene) Nanocomposites, Macromol. Rapid Commun. 2006, 27:693; Tang Y., et al., Effects Of Annealing On The Migration Behavior Of PA6/Clay Nanocomposites, Macromol. Rapid Commun. 2006, 27:1545; Tang Y., et al., Maleated Polypropylene OMMT Nanocomposite: Annealing, Structural Changes, Exfoliated And Migration, Polym. Degrad. and Stab. 2007, 92:53; Tang, Y., et al., New Aspects of Migration, Oxidation and Slow Combustion in Nanocomposites, Polym. Degrad. Stab., in print; Lewin, M., et al., The Oxidation-Migration Cycle in Polypropylene based Nanocomposites, Macromolecules 2008, 41:13-17; Huang, N., et al., Studies on the Migration in PA6-OMMT Nanocomposites: Effect of annealing on migration as evidenced by ARXPS (angle resolved x-ray photoelectron spectroscopy), PAT 2008, in print.; Lewin M., et al., Annealing, structural changes, and migration of polypropylene nanocomposites, Polymer Preprints 2007, 48(1):864.

The reasons for this migration were assumed to depend on the way the nanocomposite samples were heated. Two other reasons for migration were postulated. The gases and bubbles formed in the pyrolysis and combustion of the organic surfactant in the organoclay as well as of the polymeric matrix will drive the clay to the surface. However, in the absence of such gases or bubbles, i.e., at temperatures below the onset of the decomposition of the surfactant and of the polymer, the driving force will be thermodynamic, stemming from surface free energy differences between the matrix and the interfacial tension between the matrix and the clay. The interfacial surface tensions were shown to be much lower than those of the polymeric matrices. The moiety migrating to the surface will thus be a clay particle and some matrix molecules adhering to it.

There are two major moieties of the nanocomposite. One is the intercalated moiety that is formed by the intercalation of the polymeric matrix molecules into the gallery that exists between the two layers of aluminosilicate of which the clay is composed. These clay particles containing the intercalated polymeric matrix molecules are organized in relatively large stacks that are visible in high resolution electron microscopy. These stacks are too heavy to migrate to the surface. The migrating species is the exfoliated moiety, which is composed of the single layers of clay formed upon splitting the intercalated clay particles. Such exfoliated units are thin. In addition to the aluminosilicate clay layer, they also are composed of adhering surfactant and polymeric matrix molecules. The extent of migration is thus dependent on the extent of intercalation and consequently of exfoliation in the nanocomposite. In the case of polypropylene, intercalation occurs only when some polarity is imparted to the polymer. Oxidation during annealing of the molten polymer, such as that occurs when air is used to purge the annealing sample, greatly enhances the extent of migration. In the absence of a suitable compatibilizer for the polypropylene no migration occurs without oxidation.

The present invention comprises two parts. A first part is a novel way of preparing nanocomposites by dispersing the nanoparticle in a nonpolar polymer, preferably in the presence of a mildly oxidizing agent such as air or organic peroxides, and other oxidizing agents, and then annealing the nanocomposite at or above the glass transition temperature (T_{g}) to induce the migration of the nanoparticles from the interior bulk of the nanocomposite to the surface of the nanocomposite. A second part is the preparation of new surfaces of the nanocomposite products by inducing migration of nanoparticles to the surface of the nanocomposite products thereby increasing the concentration of the nanoparticles on the surface and producing a gradient of concentrations below the surface, namely increasing from the interior bulk of the nanocomposite product outwardly to the surface of the nanocomposite product. These enhanced surfaces improve the mechanical properties of the surface such as hardness. In this way asymmetric membranes can also be produced, which may enable separation of materials.

General illustrative methods and products:

One embodiment of the invention is a method for preparing a nanocomposite in which the surface has a different chemical composition than the interior bulk, the method comprising the steps of (a) dispersing nanoparticles in a molten polymer or in a polymer dissolved in a suitable solvent, and (b) annealing the nanocomposites at a temperature above the glass transition temperature (T_{g}) for a predetermined time thereby inducing migration of the nanoparticles to the surface of the nanocomposite and thus increasing the concentration of the nanoparticles at the surface of the nanocomposite, whereby the nanocomposite has a higher concentration of the nanoparticles at the surface of the nanocomposite, a lower concentration of the nanoparticles in the interior bulk of the nanocomposite, and a gradient of concentrations of the nanoparticles generally increasing from the interior bulk of the nanocomposite outwardly to the surface of the nanocomposite.

Another embodiment of the invention is a method for preparing new polymeric nanocomposite products, the nanocomposite polymeric product being a blend of nanoparticles and a polymer and having a surface of different chemical composition than the interior bulk, the method comprising annealing the blend of the nanoparticles and the polymer at temperatures below the melting point for a predetermined time, wherein the concentration of the nanoparticles at the surface is greater than the concentration of the nanoparticles in the interior bulk, whereby the nanocomposite product has a higher concentration of the nanoparticles proximal to the surface of the nanocomposite product and a lower concentration of the nanoparticles proximal to the interior of the nanocomposite product and thereby producing a gradient of concentrations of the nanoparticles below the surface of the nanocomposite product.

Another embodiment of the invention is a nanocomposite comprising nanoparticles dispersed in a polymer, wherein the nanocomposite surface has a higher concentration of the nanoparticles than the interior. For example, the surface concentration of nanoparticles can be up to 250% greater than the interior bulk concentration of nanoparticles. For another example, the surface concentration of nanoparticles can be up to 500% greater than the interior bulk concentration of nanoparticles. For another example, the surface concentration of nanoparticles can be 250% to 1000% greater than the interior bulk concentration of nanoparticles. For another example, the surface concentration of nanoparticles can be over 1000% greater than the interior bulk concentration of nanoparticles. In one exemplary embodiment of the invention, the surface of the nanocomposite can comprise at least 50% polyhedral oligomeric silsesquioxane.

In preferred embodiments of the invention, nanoparticles can be selected from the group consisting of POSS, montmorillonite, and organically treated montmorillonite, preferably in the exfoliated form. Also in preferred embodiments of the invention, the polymer can be selected from the group consisting of polypropylene (PP), polyethylene (PE), ethylene-propylene copolymer (EP), polyamide (PA), polyamide 6 (PA6), polyamide 66 (PA66), poly(ethyleneterephtalate) (PET), polycarbonate (PC), poly(methyl methacrylate) (PMMA), polyimide (PI), polyphenylene oxide, polystyrene, poly(butylene terephtalate) (PBT), ethylene-vinyl copolymer (EVA), polyurea, polyurethane (PU), polyacrylates, polyacrylonitril (PAN) and styrene-acrylonitrile (SAN). Also in preferred embodiments of the invention, the oxidizing agent can be selected from the group consisting of air and organic peroxides.

In preferred embodiments of the invention, the annealing can be carried out at a temperature of from about 20° C. to about 300° C., or alternatively from about 40° C. to about 200° C., or alternatively from about 50° C. to about 200° C. For example, the annealing can be carried out for a time period of from about 1 second to about 1 year, or alternatively from about 1 second to about 1 day, or alternatively from about 1 second to about 2 hours. For example, the annealing can be accomplished using microwave radiation. For example, the annealing can be carried out in an atmosphere comprising N₂ and O₂ so as to decrease sublimation of migrated nanoparticles from the surface of the nanocomposite.

In other embodiments of the invention, after dispersing the nanoparticles in the polymer in the presence of the oxidizing agent so as to form the nanoparticle/polymer blend, plastic products of various shapes and sizes made of the nanoparticle/polymer blend can be prepared.

The following examples are illustrative of the invention:

### 1. Preparation of Nanocomposites of Polypropylene

### Examples 1-5

100 grams of pristine polypropylene are blended with 5 grams of IP-44 clay (produced by Southern Clay Products, Inc.) and a given wt % of TBH was blended in the Brabender at 190° C. for 5 min at a rotation of 40 rpm. The interlayer distance d of the gallery between the 2 layers of aluminosilicate indicates the extent of intercalation. As seen in Table 1, d increases with the increase in TBH, indicating the increase in intercalation typical for a nanocomposite. This presents full evidence for the formation of a nanocomposite upon addition of TBH. A mild oxidation of polypropylene occurs and introduces sufficient polar groups in the polypropylene which make the intercalation, possible.

TABLE 1

| | “a” | “d” |
|---|---|---|
| Example No. | Wt % TBH | XRD interlayer distance |
| 1 | 0.0 | 2.60 |
| 2 | 0.5 | 2.97 |
| 3 | 0.75 | 3.24 |
| 4 | 1.0 | 3.45 |
| 5 | 2.0 | 3.65 |

TBH: Tertiary Butyl-Hydroperoxide
XRD: X-Ray Diffraction

### Example 6

Similar results are obtained when a mixture of pristine polypropylene with 5% clay is prepared by mixing in a Brabender for 5 minutes at 190° C. and 40 rotations per minute. No dispersion of the clay occurs during the mixing. When a sample of the mixed material is heated to 190° C. and the heating continues for an additional 60 minutes at this temperature under a stream of nitrogen containing 12.5% of air, a nanocomposite is formed, as evidenced by XRD. A d value of 3.11 is obtained. This indicates that a small percentage of air in the nitrogen used for purging the sample is sufficient to produce enough polar groups in the polypropylene to affect the dispersion of the clay and the formation of a nanocomposite.

### 2. Preparation of New Surfaces

### Example 7

The sample prepared in Example 6 also is heated for 60 minutes, but the percentage of air in the purging gas is 50%. The d value from XRD is 3.51. The sample then is cooled and its surface is examined spectroscopically by ATR-FTIR. The height of the peak at 1043 cm⁻¹ normalized to the peak of 1375 cm⁻¹ (CH₃ symmetric deformation) indicates the concentration of SiO on the surface, i.e. the concentration of the clay. A value of r₁=1.73 is obtained. This value is 3.6 times higher than the value of the control, r₀, of the sample obtained after the Brabender mixing and before annealing. The ratio r₁/r₀=r₂, where r₂×100 indicates the percent increase in the concentration of the clay on the surface after 60 minutes of annealing due to migration. This means that if the initial concentration of the clay on the surface after the Brabender was 5 wt %, the concentration after annealing according to Example 7 is 3.6×5=18, i.e. an increase of 360%.

### Example 8

A sample of the mixture of Example 6 is annealed for 60 minutes under a stream of air. The r₂ value is r₁/r₀ and equals here 4.35, i.e. the concentration of clay on the surface after the annealing is 4.35×5=21.75. When comparing Example 8 to Example 7 it can be seen that the increase in percentage of air from 6.25 to 50% increases greatly the extent of migration and consequently the concentration of the clay on the surface.

### Example 9

Polypropylene containing 0.5% of grafted maleic anhydride is mixed in a Brabender with 5% organically treated Montmorillonite (OMMT) of clay for minutes at 190° C. A sample of the mixture is annealed under a stream of 25% air at 225° C. for 60 minutes. The r₁=2.82, r₂=6.88 and r₀=0.41. This means that the concentration of clay of on the surface is 6.88×5=34.4.

### Example 10

A sample of polypropylene containing 1.5% grafted MA was tested on the Rockwell Hardness tester. A value for hardness was obtained of 66.35±3.43.

### Example 11

Polypropylene containing 1.5% grafted MA was mixed in a Brabender with 5% OMMT for 5 minutes at 190° C. at 40 rpm. A sample of this mixture after cooling was tested in the Rockwell Hardness tester. A hardness of 75.55±12.91 was obtained. It is seen that the nanocomposite containing 5% OMMT has an increased hardness of 13.9% due to the presence of the clay on the surface.

### Example 12

A sample of the mixture of Example 11 was annealed at 180° C. for 60 minutes under the presence of 12.5% of air. The r₁ of the annealed sample was 0.97, r₀=0.47 and r₂=2.06, i.e. the concentration of clay on the surface was 10.3 wt %. The hardness value obtained was 112.75±13.21 N/mm². The increase in the clay concentration on the surface from 5% in Example 11 to 10.3% in Example 12 brought about an increase of 49.2%.

Other kinds of nanoparticles also are being used to produce nanocomposites. These particles include several varieties of POSS. The POSS derivatives are different from the clays. They are not composed of two aluminosilicate layers close to each other with a gallery between them and in which positive ions such as Na⁺ exist and neutralize the negative charges of the aluminosilicate layers. POSS constitutes a cage composed of (SiO_{1.5}) R₈, which is silicon and oxygen in a ratio of 1:1.5, located on the eight corners of an eight-cornered cage. Various organic groups can be linked so that a variety of POSS derivatives can be produced.

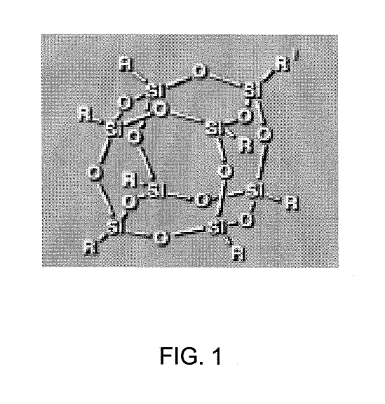

The following examples pertain to an octoisobutile POSS (OibPOSS) as seen in FIG. 1. OibPOSS is a non-polar compound. In the examples, a blend of POSS was prepared with a polymer such as polypropylene in which the POSS is dispersed, and a nanocomposite was obtained that has many properties similar to a clay based nanocomposite with regard to mechanical, thermal and optical properties. The preparation of the dispersion was carried out as follows: PP+5 wt % of POSS were mixed in a Brabender for 5 minutes at 190° C. and 40 rpm. About 5 g samples were transferred into a mold (4 mm×1 cm×4 cm), and then the samples together with the mold were pressed into a test bar at 190° C. by using a Carver Press (Model #33500-328). The bars were tested by Attenuated Total Reflection Fourier Transform Infrared Spectroscopy (ATR-FTIR). For the concentration of POSS the peak in the spectrum was at 1110 cm⁻¹ and normalized to 1375 cm⁻¹. The value obtained, r₀, corresponding to the concentration of POSS before annealing, was determined. This sample was termed the control sample.

Surprisingly, if a sample of the PP-OibPOSS blend was placed in a thermostatic oven and annealed at a temperature above the melting point of PP, a very pronounced rapid migration of POSS to the surfaces of the sample was observed. This migration occurs whether the purging gas is composed of N₂ alone or N₂ with various concentrations of air. The extent of migration of the POSS was monitored by recording the value of the ATR-FTIR peak at 1110 cm⁻¹, after normalizing it to the peak of 1375 cm⁻¹. The migration proceeds to all surfaces of the sample. Increased concentration of POSS on the bottom surface as well as on the top surface of the sample was observed. When the annealing was carried out at 190° C., the concentration of POSS on the bottom surface was higher than on the top surface. This difference is due to a sublimation of POSS from the top surface, which was open to air, while the bottom surface was not open to the air. Upon increasing the concentration of air in the purging gas the amount of POSS sublimated from the surface decreased. This indicates that air oxidizes the organic groups of the POSS to non-volatile moieties and probably crosslinks between the POSS cages are formed.

TABLE 2
Migration by annealing PP-POSS nanocomposites

| | | ATR | | | |
|---|---|---|---|---|---|
| Example | | Top Surface | | Bottom Surface | |
| No. | % Air | r₁(1110 cm⁻¹) | r₂ | r₁(1110 cm⁻¹) | r₂ |
| 13 | | r₀ = 0.76 ± 0.14 | 1 | r₀ = 0.76 ± 0.14 | 1 |
| 14 | Only N₂ | 1.12 ± 0.27 | 1.47 ± 0.36 | 2.78 ± 0.56 | 3.66 ± 0.74 |
| 15 | 12.5 | 1.53 ± .036 | 2.01 ± 0.47 | 2.88 ± 0.74 | 3.79 ± 0.97 |
| 16 | 100 | 1.92 ± 0.47 | 2.53 ± 0.62 | 2.91 ± 0.75 | 3.83 ± 0.99 |

TABLE 3
Migration by annealing PPMA-POSS nanocomposites

| | | ATR | | | |
|---|---|---|---|---|---|
| Example | | Top Surface | | Bottom Surface | |
| No. | % Air | r₁(1110 cm⁻¹) | r₂ | r₁(1110 cm⁻¹) | r₂ |
| 17 | | r₀ = 1.19 ± 0.03 | 1 | r₀ = 1.19 ± 0.03 | 1 |
| 18 | Only N₂ | 5.12 ± 0.47 | 4.30 ± 0.39 | 5.33 ± 0.87 | 4.48 ± 0.73 |
| 19 | 12.5 | 5.30 ± 0.79 | 4.45 ± 0.66 | 5.48 ± 0.74 | 4.61 ± 0.62 |
| 20 | 25 | 5.49 ± 0.98 | 4.61 ± 0.82 | 5.68 ± 0.74 | 4.71 ± 0.62 |

TABLE 4
Migration in microwave oven

| | Heating in | ATR | | | |
|---|---|---|---|---|---|
| Example | Microwave | Top Surface | | Bottom Surface | |
| No. | Oven (min) | r₁(1110 cm⁻¹) | r₂ | r₁(1110 cm⁻¹) | r₂ |

PPMA

| | | | | | |
|---|---|---|---|---|---|
| 17 | | r₀ = 1.19 ± 0.03 | 1 | r₀ = 1.19 ± 0.03 | 1 |
| 21 | 4 | 2.89 ± 0.87 | 2.43 ± 0.73 | 1.92 ± 0.41 | 1.61 ± 0.84 |
| 22 | 8 | 5.09 ± 0.90 | 4.28 ± 0.76 | 4.95 ± 0.81 | 4.16 ± 0.71 |
| 23 | 12 | 6.83 ± 1.08 | 5.74 ± 0.91 | 6.73 ± 1.17 | 5.66 ± 0.98 |
| 24 | 16 | 7.83 ± 1.24 | 6.58 ± 1.04 | 8.17 ± 0.63 | 6.87 ± 0.53 |
| 25 | 20 | 11.21 ± 1.26 | 9.42 ± 1.06 | 12.38 ± 1.29 | 10.40 ± 1.08 |

PP

| | | | | | |
|---|---|---|---|---|---|
| 13 | | r₀ = 0.76 ± 0.14 | 1 | r₀ = 0.76 ± 0.14 | 1 |
| 26 | 4 | 1.22 ± 0.17 | 1.60 ± 0.22 | 1.09 ± 0.37 | 1.43 ± 0.49 |
| 27 | 8 | 1.98 ± 0.40 | 2.61 ± 0.53 | 1.92 ± 0.71 | 2.53 ± 0.93 |
| 28 | 12 | 2.63 ± 0.71 | 3.46 ± 0.93 | 2.26 ± 0.26 | 2.97 ± 0.34 |
| 29 | 16 | 3.43 ± 0.73 | 4.51 ± 0.96 | 3.94 ± 0.82 | 5.18 ± 1.08 |
| 30 | 20 | 5.22 ± 0.49 | 5.22 ± 0.49 | 5.76 ± 0.66 | 7.58 ± 0.87 |

Examples 14-16 were prepared according to Example 13. About 5 g samples were transferred into a mold (4 mm×1 cm×4 cm), and then the samples together with the mold were pressed into a test bar at 190° C. by using a Carver Press (Model #33500-328). The obtained bar was covered with aluminum foil, leaving one surface uncovered, and then positioned into a syringe. The syringe was sealed with a silicone rubber. The syringe was then heated in a thermo stated isotemp furnace (Fisher Scientific Company) for 30 minutes. The actual temperature during annealing was monitored by a thermocouple. These samples were annealed under a stream of N₂, or N₂ containing specified ratios of air, controlled by 2 calibrated flowmeters. The flow rate of the purging gas was 800 ml/min.

### Example 14

A sample was prepared according to Example 13 and was annealed at 190° C. for 30 minutes under a stream of N₂. The sample then was cooled and tested by ATR-FTIR on the top surface and on the bottom surface. The values of r₁ and r₂ on the bottom surface are 2.78±0.56 and 3.66±0.74, respectively. The values of r₁ and r₂ on the top surface were 1.12±0.27 and 1.47±0.36, respectively. The difference in the amount of POSS between the top and the bottom surfaces is 60%, the top surface lost 60% of the migrated POSS due to sublimation.

### Example 15

A sample was prepared and annealed in a manner similar to Example 14; however, 12.5% of air was included in the N₂ stream. The value of r₂ on the bottom surface changed only slightly, but the value of r₂ on the top increase to 2.01±0.47.

### Example 16

A sample was prepared and annealed in a manner similar to Example 14; however, air instead of N₂ was used for purging the sample during annealing. The value of r₂ on the bottom change slightly, but the value of r₂ on the top is 2.53±0.62.

It is seen in these examples that the amount of sublimated POSS can be decreased by using increasing amounts of air in the purging stream of gas. It can be deduced that when increasing the rate of flow of the gas purging the sample and thus applying more air per minute, a smaller amount of POSS sublimates and the yield of migrated POSS increases on the top surface.

Example 17 describes the preparation of the control sample in which PPMA (1.5% MA) was melt blended with 5% POSS according to the conditions of Example 13.

Surprisingly, if some polarity is introduced in the PP molecules, for example if 1.5% of maleic anhydride (MA) are grafted to the PP molecules, the results obtained upon annealing this blend of PPMA with 5% OibPOSS are different, as can be seen in Examples 17-20. In the case of the PPMA-OibPOSS blends, the extent of migration, MI (migration index, =r₂), increases by about 20%, as is evident when comparing the r₂ value of Example 18 on the bottom surface (i.e., 4.48) to that of Example 14 (i.e., 3.66). The migration in Examples 14-20 theoretically is due to the polarity of the PPMA, similar to the case of the clay based nanocomposites disclosed earlier. It is to be expected that an increase in the polarity of the matrix polymer will increase the MI of POSS. Those of skill in the art will be able to control the MI by using different polarized polymers without undue experimentation.

Examples 17-20 show that the values of r₂ in the sample annealed under N₂ (Example 18) as well as under an N₂ stream containing up to 25% air (Example 20) obtained on the top and bottom surfaces are approximately the same. This indicates that there is no significant sublimation occurring in the case of the polarized PP.

Another surprising feature of this invention is the finding that the migration process can occur on polymer POSS blends also below the melting point, i.e., on the solid samples and at lower temperatures. Samples similar in size and composition to those of Examples 13 and 17 were heated in a household microwave oven (for these experiments the microwave oven used is a commercial kitchen Galaxy brand microwave oven, model 721.64002). The use of microwave energy for processing materials has the potential to offer advantages in reduced processing times and energy savings. In conventional thermal processing, energy is transferred to the material through convection, conduction, and radiation of heat from the surfaces of the material. During this heating in the microwave oven, the energy is transferred at a molecular level, which opens new possibilities. An important advantage of the microwave heating is that it heats simultaneously the whole sample and does not require time for the heat to spread to the interior of the sample, resulting in homogeneous samples.

As seen from Examples 21-30, in both PPMA and PP-POSS blends the MI values increase with increase in time of heating.

### Example 21

This describes a sample prepared according to Example 17 and heated in the microwave for 4 minutes. The value of r₂ on the top surface and on the bottom surface are the same when considering the experimental error. The temperature of the sample at the end of the 4 minutes was 96° C. The sample was heated at this temperature for only about 1 minute as it took 3 minutes of heating to bring it up to this temperature.

### Example 22

The sample from Example 21, after cooling in a desiccator, was heated for an additional 0.4 minutes. The r₂ value obtained for the top and bottom surfaces was approximately 4.2, which shows a very considerable increase from Example 21.

### Example 23

This describes a sample prepared according to Example 17 that was cooled and heated for another 4 minutes, i.e. altogether the sample was heated for 12 minutes. The r₂ value obtained for the top and bottom surfaces was approximately 5.7 showing an additional increase in the extent of the migration.

### Example 24

This describes a sample prepared according to Example 23 that was cooled and heated for another 4 minutes. The r₂ value obtained for the top and bottom surfaces was approximately 6.7, showing an additional increase in the extent of the migration. The difference in the r₂ values for the top and bottom surfaces seems to be small.

### Example 25

This describes a sample prepared according to Example 24 that was cooled and heated for another 4 minutes. The r₂ value obtained for the top and bottom surfaces was approximately 10, showing an additional increase in the extent of the migration, which, when considering the initial POSS concentration in the control sample was 5%, amounts to 50% POSS on the surface after 20 minutes of heating, i.e. an increase of 1000% in the concentration of POSS on the surface as compared to the concentration of the control.

Examples 26-30 pertain to samples prepared from pristine PP+5% OibPOSS.

### Example 26

This describes a sample prepared according to Example 13 and heated similarly to Example 21 for 4 minutes in the microwave oven. The value of r₂ for the top and bottom surfaces is approximately the same and amounts to 1.6. It behaves in a similar way as the samples based on PPMA but with a lower rate of migration.

### Example 27

The sample obtained according to the procedure of Example 26 was heated in the microwave oven for additional 4 minutes. The r₂ values for the top and bottom surfaces increases to approximately 2.58.

### Example 28

This sample relates to the sample form Example 27 that was cooled and heated for an additional 4 minutes, i.e. the sample was heated altogether for 12 minutes. The r₂ values for the top and bottom surfaces increases to approximately 3.25.

### Example 29

This sample relates to the sample from Example 28 that was cooled and heated for an additional 4 minutes, i.e. altogether for 16 minutes. The r₂ values for the top and bottom surfaces increases to approximately 4.84.

### Example 30

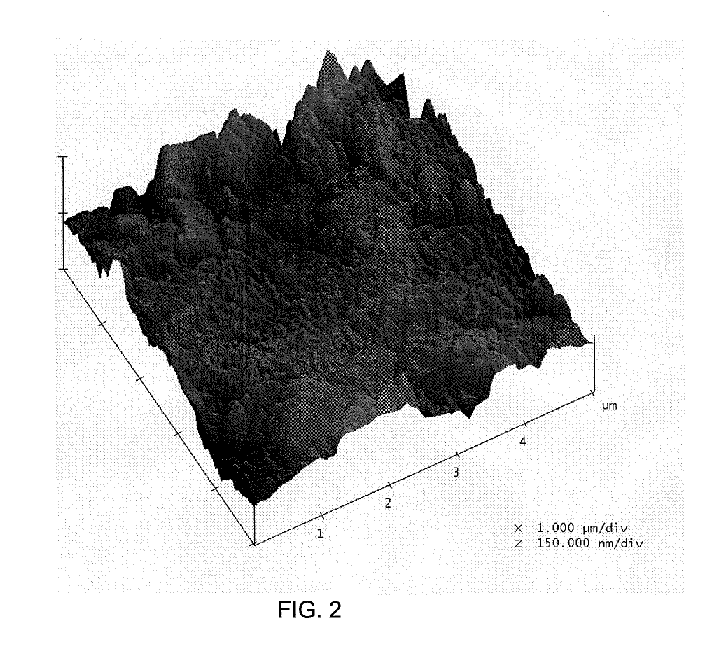

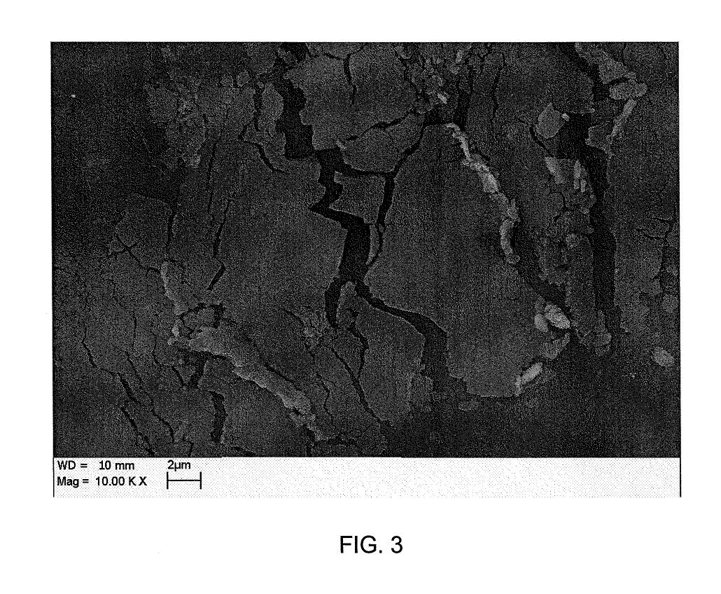

This sample relates to the sample of Example 29 that was cooled and heated for an additional 4 minutes, i.e. altogether for 20 minutes. The r₂ values for the top and bottom surfaces increases to approximately 6.4. This value is markedly lower than the value obtained under the same heating conditions for the PPMA blend in Examples 21-25. FIG. 2 is an AFM image of the surface resulting from Example 30. FIG. 3 is an SEM image of the surface resulting from Example 30.

The average value of the MI for Examples 21-25 is higher by 47% then that of Examples 26-30. This difference is higher than the 20% discussed earlier in the cases of the annealing at 190° C. of PP-POSS and PPMA-POSS. This higher rate of migration is attributed to the higher efficiency of heating of polarized polymers in the microwave oven.

### Example 31

High density polyethylene (HDPE) was melt mixed in a Brabender at 135° C. for 5 minutes. About 5 g samples were transferred into a mold (4 mm×1 cm×4 cm), and then the samples together with the mold were pressed into a test bar at 135° C. by using a Carver Press (Model #33500-328). The bars were tested by ATR-FTIR for the concentration of POSS peak in the spectrum at 1110 cm⁻¹ and normalized to 2920 cm⁻¹. The value obtained, r₀, corresponding to the concentration of POSS before annealing, was determined. This sample was termed the control sample.

The obtained bar was covered with aluminum foil, leaving one surface uncovered, and then positioned into a syringe. The syringe was sealed with a silicone rubber. The syringe was then heated in a thermostated isotemp furnace (Fisher Scientific Company) for 30 minutes. The actual temperature during annealing was monitored by a thermocouple. The sample was annealed at 135° C. under a stream of N₂ for 30 minutes, controlled by a flowmeter. The flow rate of the purging gas was 800 ml/min. The sample was then cooled and tested by ATR-FTIR on the top surface and on the bottom surface. The r₂ values are 2.73±0.97 and 6.33±1.04, respectively.

### Example 32

PA6, Ultramide B-3 NC010 was melt mixed in a Brabender at 240° C. for 5 minutes and 40 rpm. About 5 g samples were transferred into a mold (4 mm×1 cm×4 cm), and then the samples together with the mold were pressed into a test bar at 240° C. by using a Carver Press (Model #33500-328). The bars were tested by ATR-FTIR for the concentration of POSS peak in the spectrum at 1110 cm⁻¹ and normalized to 1640 cm⁻¹. The value obtained, r₀, corresponding to the concentration of POSS before annealing, was determined. This sample was termed the control sample. This sample was heated for 50 seconds in a household microwave oven (heated in the same conditions like in Example 21, except the time was different). The temperature on the top surface was 150° C. as measured with an infra-red thermometer. The sample was then cooled and tested by ATR-FTIR. On the top surface, the value r₂ was 3.25±0.95.

The experiment described in Examples 21 to 25 shows that a very high MI can be obtained upon stepwise heating a sample with cooling between the heating steps. Similar results can be obtained also by one stage heating without cooling in between. For example, a sample similar to Example 25 was prepared and was heated for 10 minutes in the same microwave oven. An MI of 70 on the bottom surface was obtained; however the MI of the top surface was found to be significantly lower due to sublimation. The longer the sample is heated in the microwave oven, the higher the temperature reached, and in this example the temperature reached was 120° C. At this temperature sublimation occurs and the MI of the top surface decreases. In order to avoid the decrease in MI due to sublimation, a lower temperature is preferable and this can be achieved by stepwise heating. Very high MI without sublimation can be obtained in the case of PP or PPMA-POSS nanocomposites by adapting a suitable stepwise heating schedule with the appropriate temperature, and those skilled in the art can plan such production schedules without undue experimentation. This is another feature of the present invention that concerns the method and schedule of annealing or heating in order to achieve migration, and is of particular importance when processing polar polymers. The rate of heating in the microwave oven increases greatly with the polarity of the polymer, as can be seen in Example 32 in which the temperature of the polyamide POSS blend sample reached a temperature 150° C. after only 50 seconds. Applying a stepwise schedule enables the design of suitable procedures for obtaining various degrees of MI for a variety of polymers.

One feature of the present invention is that the migration proceeds in all directions of the polymer POSS blend product when heated in the microwave oven. For example, when ball bearings made of a polymer POSS nanocomposite with a relatively low POSS content such as 5% are heated in the microwave oven, the POSS will migrate to all the surfaces of the ball so as to obtain a surface rich with POSS. Depending on the schedule of the heating in the commercial microwave oven, surfaces containing up to 60% of POSS and higher can be obtained in a relatively short time and in such a way to produce a new product that can be termed second generation nanocomposite. This surface is believed to have a very low friction coefficient, low wear and high abrasion resistance and a high hardness, which can be the characteristics of new ball bearings and other products of low friction surface that could be used advantageously for many applications. The low friction is clearly evidenced by atomic force microscopy (AFM) measurements of surface roughness, measured in root mean square roughness (RMS nm), and, in a diameter of the rough domains, the higher the RMS and the diameter, the lower the friction. As can be seen in Table 5, the roughness increases dramatically with the migration of the samples. The high percentage of POSS will also impart to the product a very high hydrophobicity due to the low surface tension of POSS, which is closed is that of Teflon brand fluoropolymers.

TABLE 5
AFM particle size analysis of the studied samples (see FIG. 2)

| Sample | RMS (nm) | Diameter (nm) |
|---|---|---|
| Pristine PP | 4.02 | 28.93 |
| PP/5 wt % POSS (control) Example 13 | 7.08 | 41.05 |
| PP-oib-POSS (20 min) Example 30 | 29.57 | 85.25 |
| PPMA-oib-POSS (20 min) Example 25 | 44.57 | 116.04 |

Note:
RMS is Root mean square roughness

Atomic Force Microscopy (AFM). The AFM experiments in Table 5 were performed on a MultiMode scanning probe microscope from Veeco Instruments (Santa Barbara, Calif.). A silicon probe with 125 μm long silicon cantilever, and 275 kHz resonant frequency was used for tapping mode surface topography studies. Surface topographies of the chosen samples were studied on 5 μm×5 μm scan areas with a scan rate of ca. 1.1 Hz.

TABLE 6
Contact angles with water

| Sample | Water contact angle |
|---|---|
| Pristine PP | 79.8 |
| PP + POSS - Example 13 | 85.3 |
| PP + POSS (12 min) - Example 28 | 105.4 |
| PP + POSS (20 min) - Example 30 | 109.5 |
| Pure PPMA | 66.9 |
| PPMA + POSS - Example 17 | 88.02 |
| PPMA + POSS (12 min) - Example 23 | 104.5 |
| PPMA + POSS (20 min) - Example 25 | 111.12 |

The static contact angle measurements with the probe liquids (i.e ultrapure water) were carried out on a Cam 200 Optical Contact Anglemeter, KSV Instruments at room temperature.

In can be seen in Table 6 that the contact angles of the surfaces with water increase dramatically with the increase of POSS on the surface of the samples. At a concentration of 50% POSS on the surface of a PPMA-POSS blend, a water contact angle value of 111 was obtained whereas the water contact angle of POSS itself with water reaches the value of 118. Both values are close to the value of Teflon brand polytetrafluoroethylene. For the POSS concentration, a water contact angle value of 109.5° was obtained.

As mentioned above, the principles of this invention apply to a large variety of nanocomposites prepared from many polymers of different polarity with many kinds of POSS depending on the structure of the side groups. The side groups may be composed of molecules containing additional silicon or other elements such as metallic derivatives, aromatic groups, polymeric groups, fluorine derivatives, and others. This will broaden much further the applications of POSS, especially after migration. Specific surfaces with specific properties may also be produced for a variety of additional uses.

The second generation nanocomposites as described herein have strongly enhanced surface properties. For example, for 5% and 10% POSS containing PP, the hardness values obtained were:
Pristine PP: 109 MPa.
5% POSS: 157 MPa.
10% POSS: 225 MPa.
   Extrapolated values:
30% POSS: 300 Mpa.
50% POSS: 500 Mpa.

The water contact angle for PP-oibPOSS blends found in the prior art literature increases from 72.95 for Pristine PP to 78.20 for 5% POSS and to 86.10 for 10% POSS. These values should be compared to the high values of 110-111 found according to the present invention for a similar PP-oibPOSS blend (see Table 6). These values are close to the value of 118 measured for pure oib-POSS and is close to the value for Teflon brand polytetrafluoroethylene. Similarly, the friction as measured by the ratio of the friction force/normal force decreases from 0.17 for Pristine PP to 0.14 for 5% POSS and to 0.07 for 10% POSS. It can be assumed that for 50% POSS a value close to 0.03, the value for Teflon brand polytetrafluoroethylene, will be obtained.

These vastly enhanced properties resulting from the present invention will enable the production of a large number of products of highly improved properties, for example but not limited to low-friction carpets, high-wear ball bearings, and high-ware plastic windows.

### 3. Uses

The improved nanocomposites of the present invention can have various uses of which the following are illustrative possibilities:

Producers of polyolefines, polypropylene, polyethylene and other polyolefines could produce compatibilized polar polymers for the production of nanocomposites.

Nanocomposites with enhanced surfaces according to this invention (second generation nanocomposites) would be of interest to producers of specialized nanocomposites for various applications such as for the production of ball bearings made of plastics with enhanced hardness for production of high hardness tools, high hardness and low friction automotive and aircraft parts, low friction and high wear machines parts and textiles, anti-corrosive treatments, longer shelf life plastic products, and a number of other applications.

One product can be an air impermeable film having a high concentration of the nanoparticles on the surface that can be used for packaging food, protecting electronics, and other related uses.

The development of specialized membranes, especially asymmetric membranes for separation of materials, gases, ultrafiltration and possibly for desalination of water as well as for special filters of industrial off-gases and environmental waste.

The foregoing detailed description of the preferred embodiments and the attached background materials have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. A method for preparing a nanocomposite, the nanocomposite having a surface and an interior bulk, the surface having a different chemical composition than the interior bulk, the method comprising the steps of:
a) dispersing nanoparticles in a molten polymer or in a polymer dissolved in a suitable solvent; and
b) annealing the nanocomposites for a predetermined time thereby inducing migration of the nanoparticles to the surface of the nanocomposite and thus increasing the concentration of the nanoparticles at the surface of the nanocomposite,
whereby the nanocomposite has a higher concentration of the nanoparticles at the surface of the nanocomposite, a lower concentration of the nanoparticles in the interior bulk of the nanocomposite, and a gradient of concentrations of the nanoparticles generally increasing from the interior bulk of the nanocomposite outwardly to the surface of the nanocomposite.

2. The method of preparing a nanocomposite as claimed in claim 1, wherein a mildly oxidizing agent is added while dispersing the nanoparticles in the molten polymer.

3. The method of preparing a nanocomposite as claimed in claim 1, wherein the nanoparticles are selected from the group consisting of clays, polyhedral oligomeric silsesquioxanes, montmorillonite, and organically treated montmorillonite.

4. The method of preparing a nanocomposite as claimed in claim 1, wherein the polymer is selected from the group consisting of polypropylene (PP), polyethylene (PE), ethylene-propylene copolymer (EP), polyamide (PA), polyamide 6 (PA6), polyamide 66 (PA66), poly(ethyleneterephtalate) (PET), polycarbonate (PC), poly(methyl methacrylate) (PMMA), polyimide (PI), polyphenylene oxide, polystyrene, poly(butylene terephtalate) (PBT), ethylene-vinyl copolymer (EVA), polyurea, polyurethane (PU), polyacrylates, polyacrylonitril (PAN) and styrene-acrylonitrile (SAN).

5. The method of preparing a nanocomposite as claimed in claim 2, wherein the oxidizing agent is selected from the group consisting of air and organic peroxides.

6. The method of preparing a nanocomposite as claimed in claim 3, wherein the concentration of the nanoparticles on the surface is greater than the concentration of the nanoparticles in the interior bulk.

7. The method of preparing a nanocomposite as claimed in claim 6, wherein the nanoparticles comprise up to 99% of the composition of the surface.

8. The method of preparing a nanocomposite as claimed in claim 1, wherein the annealing is carried out at a temperature of from about 20° C. to about 300° C. for a time period of from about 1 second to about 1 year.

9. The method of preparing a nanocomposite as claimed in claim 8, wherein the annealing is accomplished using microwave heating.

10. The method of preparing a nanocomposite as claimed in claim 6, wherein the nanocomposite is converted into products of predetermined sizes and shapes.

11. The method of preparing a nanocomposite as claimed in claim 8, wherein the annealing is carried out in an atmosphere comprising N₂ and O₂ so as to decrease sublimation of migrated nanoparticles from the surface of the nanocomposite.

12. A method for preparing a polymeric product, the polymeric product being a blend of nanoparticles and a polymer and having a surface and an interior bulk, the method comprising annealing the blend of the nanoparticles and the polymer at temperatures above the glass transition temperature (T_{g}) for a predetermined time, wherein the concentration of the nanoparticles on the surface is greater than the concentration of the nanoparticles in the interior bulk, whereby the polymeric product has a higher concentration of the nanoparticles proximal to the surface of the polymeric product and a lower concentration of the nanoparticles proximal to the interior of the polymeric product and thereby producing a gradient of concentrations of the nanoparticles below the surface of the polymeric product.

13. The method of preparing a polymeric product as claimed in claim 12, wherein the nanoparticles are selected from the group consisting of montmorillonite, organically treated montmorillonite, and polyhedral oligomeric silsesquioxanes.

14. The method of preparing a polymeric product as claimed in claim 13, wherein a mildly oxidizing agent is added to the blend of the nanoparticles and the polymer.

15. The method of preparing a polymeric product as claimed in claim 12, wherein the polymer is selected from the group consisting of polypropylene (PP), polyethylene (PE), ethylene-propylene copolymer (EP), polyamide (PA), polyamide 6 (PA6), polyamide 66 (PA66), poly(ethyleneterephtalate) (PET), polycarbonate (PC), poly(methyl methacrylate) (PMMA), polyimide (PI), polyphenylene oxide, polystyrene, poly(butylene terephtalate) (PBT), ethylene-vinyl copolymer (EVA), polyurea, polyurethane (PU), polyacrylates, polyacrylonitril (PAN) and styrene-acrylonitrile (SAN).

16. The method of preparing a polymeric product as claimed in claim 14, wherein the oxidizing agent is selected from the group consisting of air and organic peroxides.

17. The method of preparing a polymeric product as claimed in claim 12, wherein the nanoparticles are a polyhedral oligomeric silsesquioxane and the surface of the nanocomposite comprises at least 25% polyhedral oligomeric silsesquioxane, and the concentration of the nanoparticles on the surface is greater than twice the concentration of the nanoparticles in the interior bulk.

18. The method of preparing a polymeric product as claimed in claim 12, wherein the annealing is carried out at a temperature of from about 20° C. to about 300° C. for a time period of from about 1 second to about 1 year.

19. The method of preparing a polymeric product as claimed in claim 18, wherein the annealing is accomplished using microwave heating.

20. The method of preparing a polymeric product as claimed in claim 19, wherein the annealing is done in time limited steps and between each of the time limited steps the polymeric product is cooled down to room temperature.

21. The method of preparing a polymeric product as claimed in claim 12, wherein the annealing is carried out in an atmosphere comprising N₂ and O₂ so as to decrease sublimation of migrated nanoparticles from the surface.

22. The method of preparing a polymeric product as claimed in claim 17, wherein the nanocomposite is an air impermeable film having a high concentration of the nanoparticles on the surface.

23. A nanocomposite comprising nanoparticles dispersed in a polymer, wherein the nanocomposite has a surface and an interior bulk, the surface having a higher concentration of the nanoparticles than the interior bulk.

24. The nanocomposite as claimed in claim 23, wherein the nanoparticles are selected from the group consisting of montmorillonite, organically treated montmorillonite, and polyhedral oligomeric silsesquioxanes.

25. The nanocomposite as claimed in claim 24, wherein the nanoparticles are a polyhedral oligomeric silsesquioxane and the surface of the nanocomposite comprises at least 25% polyhedral oligomeric silsesquioxane, and the concentration of the nanoparticles on the surface is greater than the concentration of the nanoparticles in the interior bulk.

26. The nanocomposite as claimed in claim 23, wherein the polymer is selected from the group consisting of polypropylene (PP), polyethylene (PE), ethylene-propylene copolymer (EP), polyamide (PA), polyamide 6 (PA6), polyamide 66 (PA66), poly(ethyleneterephtalate) (PET), polycarbonate (PC), poly(methyl methacrylate) (PMMA), polyimide (PI), polyphenylene oxide, polystyrene, poly(butylene terephtalate) (PBT), ethylene-vinyl copolymer (EVA), polyurea, polyurethane (PU), polyacrylates, polyacrylonitril (PAN) and styrene-acrylonitrile (SAN).

27. The nanocomposite as claimed in claim 25, wherein the nanocomposite has a surface comprising at least 50% polyhedral oligomeric silsesquioxane.

28. A polymer product comprising nanoparticles dispersed in a polymer, wherein the polymer product has a surface and an interior bulk, the surface having a higher concentration of the nanoparticles than the interior bulk.

29. The polymer product as claimed in claim 28, wherein the nanoparticles are selected from the group consisting of montmorillonite, organically treated montmorillonite, and polyhedral oligomeric silsesquioxanes.

30. The polymer product as claimed in claim 28, wherein the polymer is selected from the group consisting of polypropylene (PP), polyethylene (PE), ethylene-propylene copolymer (EP), polyamide (PA), polyamide 6 (PA6), polyamide 66 (PA66), poly(ethyleneterephtalate) (PET), polycarbonate (PC), poly(methyl methacrylate) (PMMA), polyimide (PI), polyphenylene oxide, polystyrene, poly(butylene terephtalate) (PBT), ethylene-vinyl copolymer (EVA), polyurea, polyurethane (PU), polyacrylates, polyacrylonitril (PAN) and styrene-acrylonitrile (SAN).

31. The polymer product as claimed in claim 29, wherein the polymer product has a surface comprising at least 25% polyhedral oligomeric silsesquioxane.

32. The polymer product as claimed in claim 31, wherein the polymer product has a surface comprising up to 99% polyhedral oligomeric silsesquioxane.

33. The polymer product as claimed in claim 32, wherein the polymer product is an air impermeable film having a high concentration of the nanoparticles on the surface.
